(19) United States
(12) Patent Application Publication
(10) Pub. No.: US 2022/0195354 A1
(43) Pub. Date: Jun. 23, 2022

(54) SYSTEM, CLOSURE, AND INTERCONNECT FOR MANAGING A BEVERAGE IN A BULK LIQUID CONTAINER

(71) Applicant: BARRELWISE TECHNOLOGIES LTD., Vancouver (CA)

(72) Inventors: David E. Sommer, Vancouver (CA); Miayan Yeremi, Vancouver (CA); Adrien Mathias Noble, North Vancouver (CA)

(21) Appl. No.: 17/605,535

(22) PCT Filed: May 8, 2020
(86) PCT No.: PCT/CA2020/050633

§ 371 Date: Oct. 21, 2021

Related U.S. Application Data
(60) Provisional application No. 62/846,526, filed on May 10, 2019.

(51) Int. Cl. C12H 1/22; B67C 3/30

(52) U.S. Cl. CPC C12H 1/22; B67C 3/30

(57) ABSTRACT

A system, method, and apparatus for managing a beverage held in bulk liquid beverage container is disclosed. The container has a closure sealingly received within an opening of the container, the closure including an outwardly disposed closure interface including first and second fluid ports. The system includes an interconnect having an interface in fluid communication with a primary fluid line and a secondary fluid line, the interface being operable to couple to the closure interface to place the primary fluid line in fluid communication with the first fluid port and the secondary fluid line in fluid communication with the second fluid port. The system also includes a fluid handler including a plurality of fluid flow elements in fluid communication with the primary fluid line and the secondary fluid line, and a controller operably configured to control operation of the plurality of fluid flow elements to perform operations for managing the beverage.

### RELATED APPLICATIONS

This application claims the benefit of provisional patent application 62/846,526 entitled “WINE BARREL AND BUNG SYSTEM”, filed on May 10, 2019 and incorporated herein by reference in its entirety.

### BACKGROUND

### 1. Field

This disclosure relates generally to a system for performing operations for managing a beverage held in bulk liquid beverage container.

### 2. Description of Related Art

In the beverage industry, bulk liquid beverages are often held in large containers for processing. In particular, alcoholic beverages may be fermented in containers and subsequently held in containers for a period of time to age the beverage. In the case of wine production, the time spent in containers may be significant and often extends over months or years. Ageing is of importance to the development of many varieties and styles of alcoholic beverages, including wine, brandy, Scotch whiskey, tequila, and beer. For wine and beer in particular, a relatively low alcohol content makes the product vulnerable to chemical and microbial spoilage.

High-quality beverages may be aged in oak barrels, also known as barriques or casks, in the same way they have been for centuries. Traditional barrel management involves significant time and labor resources, which are typically inefficient and may in some cases compromise product quality due to potential exposure to oxygen and microbes. When wine or another beverage is stored in a container, the liquid may evaporate over time. Particularly wooden barrels, evaporation occurs through joints between staves and/or pores in the wood. The evaporation leaves an air-filled gas pocket above a surface of the liquid, which is called the headspace. The rate at which evaporation occurs depends on the wood type, barrel construction, humidity of the atmosphere, air movement, ambient temperature, and many other factors. Evaporative losses may range from about 2% to over 10% per year. Additionally, the formation of the headspace and the associated air exposure of the barrel contents may result in undesirable changes to the wine. For example, oxidation of the wine with atmospheric oxygen may cause undesirable changes to the colorants, tannins, and aromatic compounds of the wine.

To mitigate against this potential oxidation of the wine due to the headspace, barrels are generally opened and filled or topped with wine by hand once or twice per month. The topping exercise displaces the oxygen-containing headspace. Manual topping is very labor-intensive and time-consuming. Additionally, because the topping process requires removal of a cork or bung sealing an opening in the barrel, the wine may be exposed to oxygen and potentially harmful microbes in the atmosphere. Regular removal of the bung thus represents a microbial contamination risk, which could in some cases result in spoilage of the beverage in the barrel. Additionally, for monitoring purposes the wine may be sampled regularly by withdrawing a sample from the opening, which may then be analyzed in a laboratory. This results in additional atmospheric exposure and potential contamination.

There remains a need for improved methods and equipment for performing beverage management functions.

### SUMMARY

In accordance with one disclosed aspect there is provided a closure apparatus for a bulk liquid beverage container. The closure apparatus includes a body operably configured to be sealingly received within an opening of the container, the body having an outwardly disposed closure interface including first and second fluid ports each sealed by a valve. The apparatus also includes a first conduit extending through the body from the first fluid port and having an end disposed to be immersed within a liquid content of the container when the body is received in the opening. The apparatus further includes a second conduit extending through the body from the second fluid port and having an end disposed for fluid communication with an interior of the container when the body is received in the opening. The first and second fluid ports are configured to be placed in fluid communication with fluid lines of an interconnect when the interconnect is coupled to the closure interface.

The first conduit may further include a dip tube in fluid communication with the first conduit and protruding beyond the body, and the end of the first conduit may be disposed at an end of the dip tube.

The closure interface may include one of a cylindrical protrusion disposed on the body, the cylindrical protrusion configured to be received within a cylindrical recess of the interconnect, or a cylindrical recess in the body, the cylindrical recess configured to receive a cylindrical portion of the interconnect.

The cylindrical protrusion may include a first cylindrical protrusion disposed on the body and a second cylindrical protrusion disposed on the first cylindrical protrusion, and wherein the valve may include at least one displaceable valve disposed on the second cylindrical protrusion and associated with the second conduit, and at least one displaceable valve disposed on the first cylindrical protrusion and associated with the second conduit.

The apparatus may include a circumferential groove on a sidewall of the cylindrical protrusion, the cylindrical groove being operably configured to be engaged by a retainer for interlocking the interconnect and the closure apparatus when the interconnect is coupled to the closure interface.

The valve may include at least one displaceable valve associated with the first conduit, and at least one displaceable valve associated with the second conduit.

The at least one displaceable valve associated with the second conduit may be operably configured to open when the interconnect is coupled to the closure interface.

The at least one displaceable valve associated with the first conduit may be operably configured to remain closed when the interconnect is initially coupled to the closure interface, and open in response to being actuated to open by the interconnect.

The interconnect may include a primary valve sealing the primary fluid line, the primary valve being actuable to open to permit inflow or outflow of fluid through the primary fluid line, and the at least one displaceable valve associated with the first conduit may be actuated when the primary valve is opened.

The second fluid port may include a plurality of fluid ports each having an associated second conduit portion extending through the body and having respective ends disposed for communication with the interior of the container.

An interconnect apparatus for coupling to the closure interface of the closure apparatus above may include a body, an interconnect interface, and a primary fluid line extending through the body and terminating in a primary fluid port at the interconnect interface, the primary fluid port being disposed to be placed in fluid communication with the first conduit when the interconnect interface is coupled to the closure interface, and a secondary fluid line extending through the body and terminating in a secondary fluid port at the interconnect interface, the secondary fluid port disposed to be placed in fluid communication with the second conduit when the interconnect interface is coupled to the closure interface.

The interconnect apparatus may include a primary valve sealing the primary fluid port, the primary valve being operable to open to permit inflow or outflow of fluid through the primary fluid port when actuated.

In accordance with another disclosed aspect there is provided an interconnect apparatus for coupling to a closure sealingly received within an opening of a bulk liquid container, the closure including a closure interface having first and second fluid ports. The interconnect apparatus includes a body, and an interconnect interface including a primary fluid port in fluid communication with a primary fluid line extending through the body. The apparatus also includes a secondary fluid port in fluid communication with a secondary fluid line extending through the body, the primary fluid port and the secondary fluid port being disposed to be placed in fluid communication with the respective first and second fluid ports of the closure when the interconnect interface is coupled to the closure interface. The apparatus further includes a primary valve sealing the primary fluid port, the primary valve being operable to open to permit inflow or outflow of fluid through the primary fluid port when actuated.

The secondary fluid port may include a delivery port for delivering fluid flow and a discharge port for discharging fluid.

The interconnect interface may include a cylindrical protrusion configured to be received in a cylindrical recess of the closure interface.

The interconnect interface may include a cylindrical recess configured to receive a cylindrical protrusion of the closure interface.

The cylindrical recess may include a first cylindrical recess disposed to couple with a first cylindrical protrusion of the closure interface and a second cylindrical recess disposed to couple with a second cylindrical protrusion of the closure interface, the second cylindrical recess being in fluid communication with the primary fluid port.

The secondary fluid port may include a first delivery port for delivering fluid flow to the first cylindrical recess and a first discharge port for discharging fluid from the first cylindrical recess, and a second delivery port for delivering fluid flow to the second cylindrical recess and a second discharge port for discharging fluid from the second cylindrical recess.

The primary fluid line may include a plurality of primary fluid lines terminating into a manifold within the body, the manifold being in fluid communication with the primary fluid port.

The apparatus may include a flow indicator for detecting an outflow of bulk liquid through the secondary fluid port.

The flow indicator may include one of a sight glass disposed on the body to facilitate observation of a fluid flowing through the secondary fluid line, an optical sensor disposed to detect changes in flow through the secondary fluid line, or a resistive sensor disposed to sense changes in resistivity associated with flows through the secondary fluid line.

The interconnect may be operably configured for one of removably coupling to the closure, or forming a unitary interconnect and closure.

In accordance with another disclosed aspect there is provided a method for performing a topping operation on a bulk liquid beverage container, the container having a closure sealingly received within an opening of the container, the closure including a closure interface having first and second fluid ports. The method involves coupling an interconnect having an interconnect interface to the closure interface of the closure to place a primary fluid port of the interconnect in fluid communication with the first fluid port and a secondary fluid port of the interconnect in fluid communication with the second fluid port. The method also involves causing a primary valve sealing the primary fluid port to open to permit an inflow of a topping liquid through the primary fluid port and though the first fluid port of the closure, and causing a reduction of pressure at the secondary fluid port to permit a fluid to vent through the secondary fluid port while topping up a level of the bulk fluid in the container.

The method may involve causing the primary valve to close to discontinue the inflow of fluid the topping liquid in response to detecting an outflow of bulk liquid through the secondary fluid port.

The method may further involve agitating the bulk liquid within the container by at least one of modulating a flow rate or pressure associated with the flow of topping liquid, or injecting a gaseous fluid into the topping liquid.

Detecting the outflow of bulk liquid may involve detecting a transition between venting of a gaseous headspace initially present within the container and venting of the bulk liquid after the gaseous headspace has been displaced by the topping liquid.

The topping liquid may include a liquid of a similar constitution to the bulk liquid.

The method may involve mixing an additive liquid in with the topping liquid for delivering the additive liquid to the container.

The method may involve metering a dosage of additive liquid mixed in with the topping liquid and discontinuing delivery of the additive liquid in response to reaching a target metered dosage.

The method may further involve, prior to permitting the inflow of a topping liquid, delivering a sanitizer flow to the interconnect interface and the closure interface via the secondary fluid port.

The secondary fluid port may include a delivery port and a discharge port and delivering the sanitizer flow may involve delivering a sanitizer flow through the delivery port while facilitating venting of the sanitizer flow through the discharge port.

Delivering the sanitizer flow may involve delivering a first flow of liquid sanitizer followed by a second gaseous flow to cause the liquid sanitizer to be discharged from the interconnect interface and the closure interface via the discharge port.

The method may further involve, prior to coupling the interconnect interface to the closure interface, delivering a sanitizer flow through the primary fluid line for sanitizing at least one of: the primary fluid line; the primary fluid port; a manifold within the body, wherein the primary fluid line may include a plurality of primary fluid lines terminating into a manifold within the body, the manifold being in fluid communication with the primary fluid port; and the interconnect interface.

In accordance with another disclosed aspect there is provided a method for sampling a beverage being held in a bulk liquid beverage container, the container having a closure sealingly received within an opening of the container, the closure including a closure interface having first and second fluid ports. The method involves coupling an interconnect having an interconnect interface to the closure interface of the closure to place a primary fluid port of the interconnect in fluid communication with the first fluid port and a secondary fluid port of the interconnect in fluid communication with the second fluid port. The method also involves causing a primary valve sealing the primary fluid port to open to permit an outflow of the beverage from the first fluid port of the closure and through the primary fluid port. The method further involves delivering a gaseous fluid flow to the secondary fluid port to increase a pressure within the container to cause the outflow of the bulk liquid from the first fluid port.

In accordance with one disclosed aspect there is provided a system for managing a beverage held in bulk liquid beverage container, the container having a closure sealingly received within an opening of the container, the closure including and outwardly disposed closure interface including first and second fluid ports. The system includes an interconnect having an interconnect interface in fluid communication with a primary fluid line and a secondary fluid line, the interconnect interface being operable to couple to the closure interface to place the primary fluid line in fluid communication with the first fluid port and the secondary fluid line in fluid communication with the second fluid port. The system also includes a fluid handler including a plurality of fluid flow elements in fluid communication with the primary fluid line and the secondary fluid line. The system further includes a controller operably configured to control operation of the plurality of fluid flow elements to perform operations for managing the beverage.

The fluid handler may further include a sample analyzer and the controller may be operably configured to cause a draw a beverage sample of the bulk liquid to be drawn from the container through the primary fluid line via the first port of the closure, and to deliver the beverage sample to the sample analyzer for performing a sample analysis.

The controller may be further operably configured to perform at least one beverage management function based on the result.

The beverage management function performed by the controller may involve calculating a target dosage of an additive liquid to be delivered to the bulk liquid to the container, and generating control signals for controlling delivery of the target dosage of additive liquid to the bulk liquid via the interconnect and through the first fluid port.

The beverage management function performed by the controller may involve storing the result in a memory of the controller processor circuit, and downloading or transmitting the result to a centralized management processing system for further processing.

Other aspects and features will become apparent to those ordinarily skilled in the art upon review of the following description of specific disclosed embodiments in conjunction with the accompanying figures.

### BRIEF DESCRIPTION OF THE DRAWINGS

In drawings which illustrate disclosed embodiments,

FIG. 1 is a perspective view of a system for managing a beverage held in bulk liquid beverage container according to a first disclosed embodiment;

FIG. 2A is a perspective view of a closure of the system shown in FIG. 1;

FIG. 2B is a cross sectional view of the closure of shown in FIG. 2A;

FIG. 3A is a perspective view of an interconnect of the system shown in FIG. 1;

FIG. 3B is a rear elevational view of the interconnect shown in FIG. 3A;

FIG. 3C is a bottom perspective view of the interconnect shown in FIG. 3A;

FIG. 3D is a cross sectional view of the interconnect shown in FIG. 3A coupled to the closure shown in FIG. 2B;

FIG. 3E is an elevational view of a unitary interconnect in accordance with another embodiment of the invention;

FIG. 4A is a perspective view of an alternative embodiment of a closure for the system shown in FIG. 1;

FIG. 4B is a cross sectional view of the closure of shown in FIG. 4A;

FIG. 5A is an elevational view of an alternative embodiment of an interconnect and closure;

FIG. 5B is a perspective view of a portion of the interconnect shown in FIG. 5A;

FIG. 6 is a schematic diagram of connections between a fluid handler shown, interconnect, a hand controller, and closure shown in FIG. 1;

FIG. 7 is a block diagram of a processor circuit for implementing a controller shown in FIG. 1 and FIG. 6;

FIG. 8 is a process flowchart depicting blocks of codes for directing the controller processor circuit of FIG. 7 to implement a clean process;

FIG. 9 is a process flowchart depicting blocks of codes for directing the controller processor circuit of FIG. 7 to implement a purge process;

FIG. 10 is a process flowchart depicting blocks of codes for directing the controller processor circuit of FIG. 7 to implement a topping process; and

FIG. 11 is a process flowchart depicting blocks of codes for directing the controller processor circuit of FIG. 7 to implement a sample process.

### DETAILED DESCRIPTION

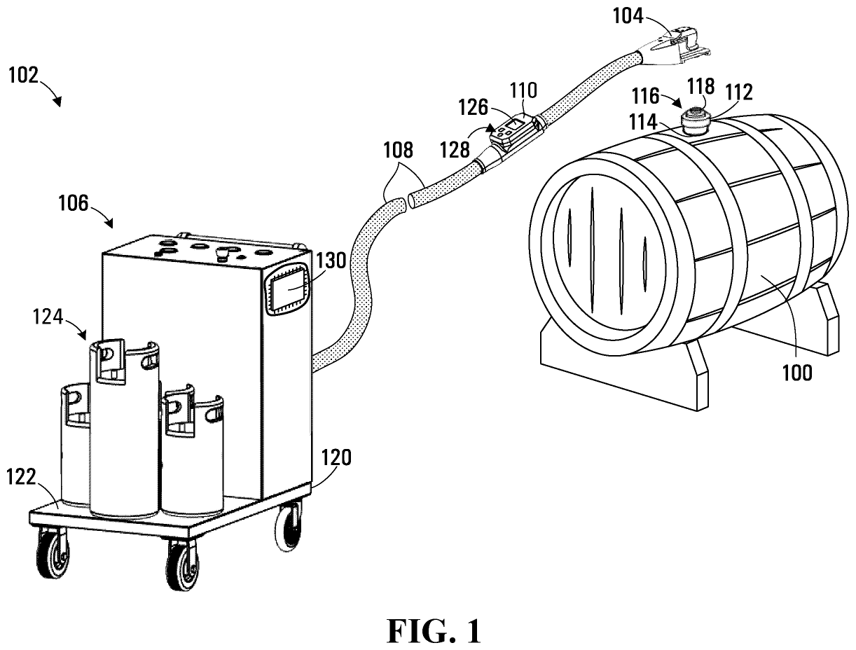

Referring to FIG. 1, a system for managing a beverage held in bulk liquid beverage container 100 according to a first disclosed embodiment is shown generally at 102. The system 102 includes an interconnect 104 and a fluid handler 106. The interconnect 104 is connected back to the fluid handler 106 via a fluid line 108. In this embodiment the system 102 also includes a hand controller 110 disposed in-line with the fluid line 108 at a location proximate the interconnect 104.

In this embodiment the container 100 is a wooden barrel, typically used for holding a wine or spirit beverage. In other embodiments the container 100 may be a steel or stainless steel tank, a concrete container, or any other bulk liquid container used in the beverage industry. The container 100 has a closure 112 sealingly received within an opening 114 of the container. The closure 112 has an outwardly disposed closure interface 116. The interconnect 104 is configured to connect to the closure interface 116 to place the fluid line 108 in fluid communication with the container 100 via the interconnect 104. The closure interface 116 includes a cylindrical protrusion 118 configured to be received within a cylindrical recess of the interconnect 104 (not visible in FIG. 1).

The fluid handler 106 is disposed on a wheeled cart 120, which has a support surface 122 for supporting a plurality of reservoirs 124 for holding fluids associated with managing the beverage in the container 100. The fluid handler 106 also houses valves, pumps, and other elements associated with operation of the system 102, which will be described in more detail below. When the interconnect 104 is connected to the closure 112, fluids may be transferred along the fluid line between the fluid handler 106 and the container 100. For example, a fluid from one of the plurality of reservoirs 124 may be transferred over the fluid line 108 to the container 100. Alternatively, fluid from the container 100 may be transferred over the fluid line 108 to the fluid handler 106 and the fluid handler may deliver the fluid to one of the plurality of reservoirs 124. The fluid line 108 may be several meters in length to permit the interconnect 104 to reach a plurality of different containers 100 disposed in an area. In a winery, a large number of containers 100 (such as shown in FIG. 1) may be maintained within a cellar for ageing or otherwise processing wine. In many cases, to save space the containers may be stacked in several tiers and the fluid line 108 may be made long enough to reach containers in several tiers.

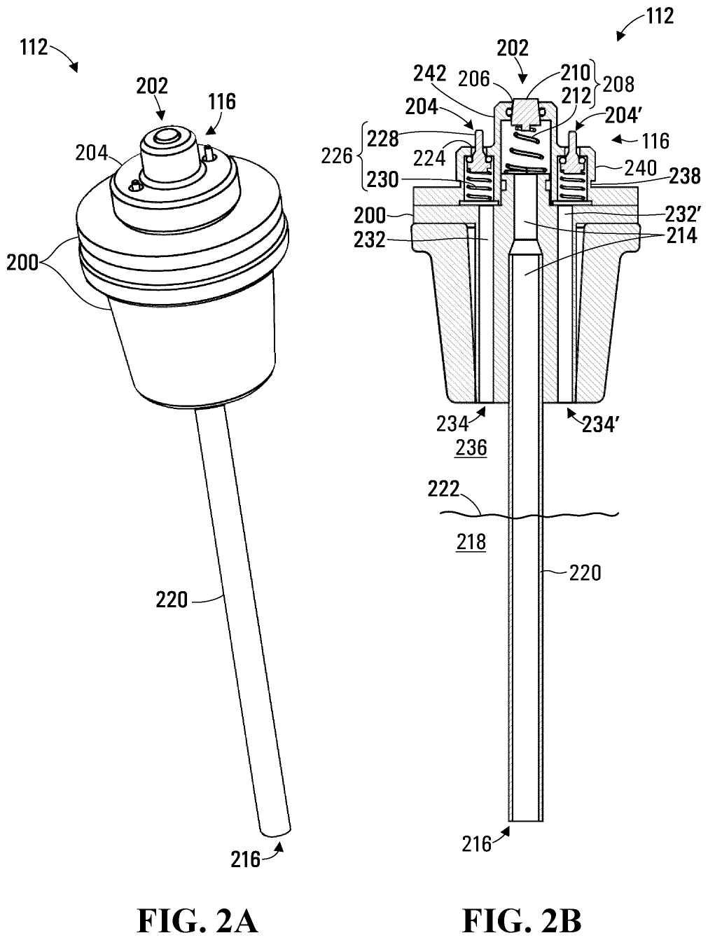

The closure 112 is shown in more detail in FIGS. 2A and 2B. Referring to FIG. 2A, the closure includes a body 200 operably configured to be sealingly received within the opening 114 of the container 100. The closure interface 116 includes a first fluid port 202 and a second fluid port 204. The closure 112 is shown in cross-section in FIG. 2B. The first fluid port 202 is provided by an opening 206 within the closure interface 116, which is sealed by a first displaceable valve 208. In this embodiment the first valve 208 includes a displaceable plug 210 urged upwardly by a spring 212 to seal the opening 206. The closure 112 further includes a first conduit 214, which extends through the body 200 from the first fluid port 202. The first valve 208 is configured to be displaced when a force is exerted on the plug 210, causing the spring 212 to be compressed such that fluid flow is permitted between the opening 206 and the first conduit 214. The first conduit 214 terminates in an end 216 disposed to be immersed within a liquid content 218 of the container 100 when the body 200 is received in the opening 114 of the container 100. In this embodiment the first conduit 214 includes a dip tube 220 that protrudes beyond the body 200, and the end 216 is disposed at the end of the dip tube. The length of the dip tube 220 is selected to extend the first conduit 214 to cause the end 216 to be disposed below a surface 222 of the liquid content 218.

The second fluid port 204 is provided by an opening 224 within the closure interface 116, which is sealed by a second displaceable valve 226. The second valve 208 includes a displaceable plug 228 urged upwardly by a spring 230 to seal the opening 224. The closure 112 further includes a second conduit 232, which extends through the body 200 from the second fluid port 204. The second valve 226 is configured to be displaced when a force is exerted on the plug 228, causing the spring 230 to be compressed such that fluid flow is permitted between the opening 224 and the second conduit 232.

In this embodiment the closure interface 116 includes a first cylindrical protrusion 240 disposed on the body and a second cylindrical protrusion 242 disposed on the first cylindrical protrusion. The second fluid port 204 is disposed on the first cylindrical protrusion 240 and the first fluid port 202 is disposed on the second cylindrical protrusion 242.

The second conduit 232 has an opening 234 disposed for fluid communication with an interior 236 of the container 100 when the body 200 is received in the opening. In this embodiment the second fluid port is implemented as a pair of fluid ports 204 and 204′, where the fluid port 204′ is identically configured and serves to provide for increased flow through respective second conduits 232 and 232′. The conduit 232′ terminates in an opening 234′ in fluid communication with the interior 236 of the container 100. While in the embodiment shown, the second fluid port includes a plurality of fluid ports 204 and 204′ in other embodiments there may be only a single second fluid port 204.

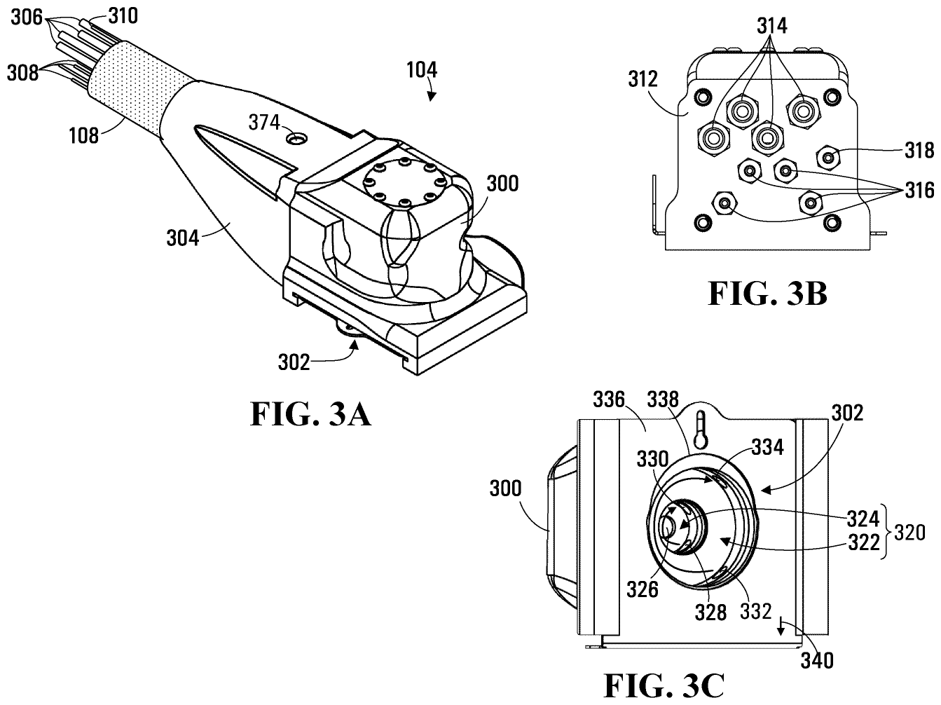

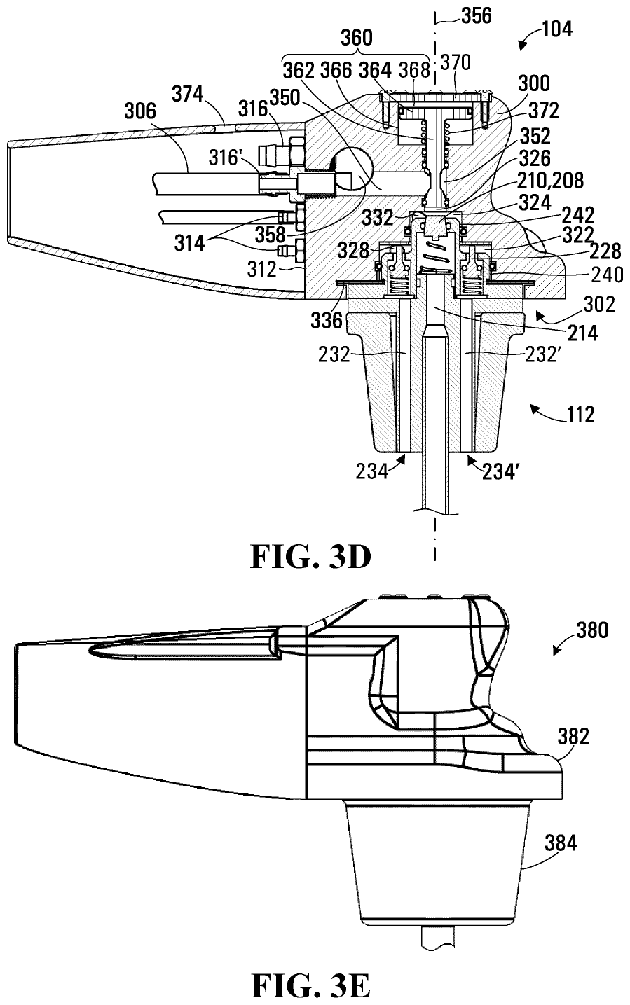

The interconnect 104 is shown in greater detail in FIGS. 3A-3D. Referring to FIG. 3A, the interconnect 104 includes a body 300, which encloses an interconnect interface 302 disposed within an underside of the body (not visible in FIG. 3A). The fluid line 108 feeds in through a rear cover 304, and in this embodiment includes a first plurality of 4 fluid lines 306, which are together referred to herein as the primary fluid line. The fluid line 108 also includes a second plurality of 4 fluid lines 308 in this embodiment, which are together referred to as the secondary fluid line. In other embodiments there may be a greater or lesser number of fluid lines making up the primary and/or secondary fluid lines. In this embodiment the fluid line 108 further includes a single pneumatic actuator line 310.

The interconnect 104 is shown in FIG. 3B with the rear cover 304 removed to reveal a bulkhead portion 312 of the body 300. The bulkhead 312 accommodates fluid connections 314 for connecting the primary fluid lines 306, fluid connections 316 for connecting the secondary fluid lines 308, and a fluid connection 318 for connecting the pneumatic actuator line 310.

Referring to FIG. 3C, a bottom perspective view of the interconnect 104 shows details of the interconnect interface 302. The interconnect interface 302 includes a cylindrical recess 320, which in this embodiment is configured as a first cylindrical recess 322 and a second cylindrical recess 324. The cylindrical recess 320 is configured to receive corresponding cylindrical protrusions of the closure interface 116 of the closure 112.

The primary fluid lines 306 connect via the fluid connections 314 and combine within the body 300 to terminate in a primary fluid port 326. The secondary fluid lines 308 connect via the fluid connections 316, and terminate in secondary fluid ports 328, 330, 332, and 334. In this embodiment, the secondary fluid ports 328 and 330 are located within the second cylindrical recess 324, and in operation one of the ports may be configured as a delivery port for delivering fluid flow and the other as a discharge port for discharging fluid. Similarly, the secondary fluid ports 332 and 334 are located within the first cylindrical recess 322 and in operation one of the ports may be configured as a delivery port for delivering fluid flow and the other as a discharge port for discharging fluid.

The interconnect 104 is shown in cross sectional view in FIG. 3D. The fluid connections 314 and 316 mounted on the bulkhead portion 312 of the body 300 are connected to the respective primary fluid port 326 and secondary fluid ports 328, 330, 332, and 334 (shown in FIG. 3C), via channels formed through the body. The fluid connection 314′, which is one of the fluid connections 314, is centrally located with respect to the bulkhead 312. The fluid connection 314 is located in a primary bore 350 that extends into the body 300 and terminates in fluid communication with a valve bore 352. The valve bore 352 is aligned with an axis 356 and terminates in an opening that acts as the primary fluid port 326. The fluid connection 316′ is thus connected via the primary bore 350 to the primary fluid port 326. The body 300 has a transverse manifold bore 358 extending into the page in FIG. 3D, which intersects with the primary line bore 350. The remaining fluid connections 316 terminate in fluid communication with the manifold 358, placing all of the fluid connections 316 in fluid communication with the primary line bore 350.

In FIG. 3D, the interconnect interface 302 is shown coupled to the closure interface 116 of the closure 112. The first cylindrical recess 322 of the interconnect 104 receives the first cylindrical protrusion 240 of the closure interface 116. The second cylindrical recess 324 receives the second cylindrical protrusion 242.

In the embodiment shown, the interconnect interface 302 includes a retainer 336. The retainer 336 is more clearly shown in FIG. 3C. The retainer 336 is configured as a sliding plate having an opening 338 sized to permit the closure interface 116 of the closure 112 to pass through the opening and into the first cylindrical recess 322. The opening 338 of the retainer 336 is urged by a spring (not shown) to be initially offset with respect to the first cylindrical recess 322. Referring back to FIG. 2B, the closure 112 further includes a circumferential groove 238 on a sidewall of the closure interface 116, which is sized to receive the retainer plate 336 to interlock the interconnect and the closure apparatus when coupled. When the retainer 336 is displaced by a force applied in the direction indicated by the arrow 340, the opening 338 aligns with the first cylindrical recess 322 and the closure interface 116 is able to pass through the opening 338 into the interconnect interface 302. When the retainer 336 is released, the spring urges the retainer plate in a direction opposite to the arrow 340 and engages the circumferential groove 238 to lock the interconnect 104 and closure 112 together.

When the closure interface 116 is received in the interconnect interface 302, the plug 228 of the second valve 226 is depressed, causing the second conduit 232 to be placed in fluid communication with the second cylindrical recess 324 and thus the secondary fluid ports 328 and 330. Similarly, for the second fluid port 204′, the associated plug will be depressed placing the second conduit 232′ in fluid communication with the first cylindrical recess 322, and thus the secondary fluid ports 328 and 330. The valve 226 and the valve associated with the second fluid port 204′ are thus operably configured to open when the interconnect 104 is coupled to the closure interface 116.

The displaceable plug 210 of first valve 208 is configured to remain closed when the interconnect 104 is initially coupled to the closure interface 116. The interconnect 104 further includes a primary valve 360 sealing the primary fluid port 326. The primary valve 360 includes a valve stem 362, which is received within the primary fluid line valve bore 352 and configured for movement in the direction to the axis 356. The primary valve 360 also includes a piston 364 connected to the valve stem 362. The piston 364 is received within a bore 366, which may be pressurized by a fluid pressure delivered via the fluid connection 318 (FIG. 3B) to an upper portion 368 of the bore 366. The fluid connection 318 may be connected to the upper portion 368 of the bore 366 via a conduit extending through the body 300 or via an external line connected through a cover plate 370 enclosing the bore 366. The fluid pressure may be provided by a compressed air source or other source of pressurized gas.

To open the primary valve 360, fluid pressure applied within the upper portion 368 of the bore 366 drives the piston 364 downwardly causing the valve stem 362 to move within the valve bore 352, placing the primary bore 350 in fluid communication with the second cylindrical recess 324. When the valve stem 362 is displaced downwardly, a lower end of the step contacts the plug 210 and displaces it downwardly to cause the first valve 208 of the closure 112 to open, placing the second cylindrical recess 324 in fluid communication with the first conduit 214. A spring 372 urges the piston 364 upwardly, such that the primary valve 360 remains closed when not actuated by fluid pressure. The primary valve 360 is thus actuable to open to permit an inflow or outflow of fluid between any of the primary fluid lines 306, via the manifold 358, primary bore 350, and the primary fluid port 326.

An alternative embodiment of a unitary interconnect/closure is shown in FIG. 3E at 380. Referring to FIG. 3E, the unitary interconnect 380 includes an interconnect portion 382 and a closure portion 384. In this embodiment the closure portion 384 is not removable from the interconnect portion 382. The container 100 may have the opening 114 initially sealed using a conventional bung, which may be removed, and the unitary assembly inserted into the opening for performing beverage management operations.

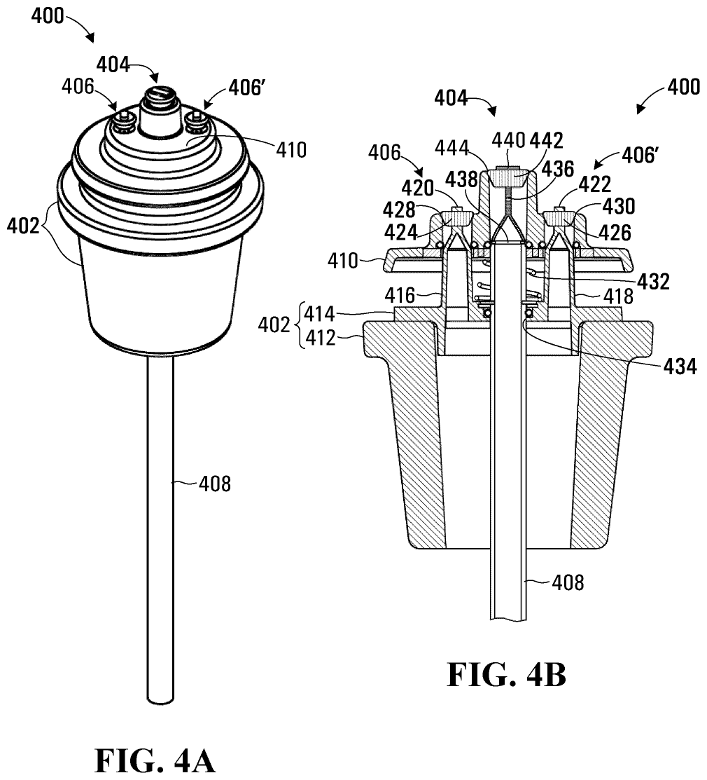

Referring to FIG. 4A, an alternative embodiment of a closure is shown generally at 400. The closure 400 has a body 402, a first fluid port 404, second fluid ports 406 and 406′, and a dip tube 408 generally as described above in connection with the closure 112. In this embodiment the closure interface is implemented as a cap 410 that is downwardly displaceable to open the fluid ports 404, 406, and 406′ as shown in FIG. 4A.

The closure 400 is shown in cross section in FIG. 4B. The body 402 includes a bung portion 412 that is configured to be received within the opening 114 of the container 100. The bung portion 412 may be fabricated from a compliant material, such as silicone. The body 402 further includes an insert 414, which is sealingly attached to the bung portion 412, for example via a press fit or by bonding the portions together. The insert 414 may be a molded thermoplastic, for example. The insert 414 includes a pair of valve supports 416 and 418, each of which terminate in a retainer 420 and 422 at an upper end of the support. The cap 410 fits over the valve supports 416 and 418, which each receive respective compliant valve plugs 424 and 426 at upper ends thereof. The retainers 420 and 422 hold the valve plugs 424 and 426 in place on the respective valve supports 416 and 418. In FIG. 4b, the cap is shown urged upwardly by a spring 432, such that the valve plugs 424 and 426 close off respective openings 428 and 430 in the cap 410.

The dip tube 408 extends through a bore 434 in the insert 414 and terminates at an upper end within a corresponding bore in the cap 410. The fluid port 404 includes a valve support 436 that has an annular base 438 received within the terminal end of the dip tube 408 within the cap 410. The valve support 436 includes a retainer 440 at an upper end of the support. The cap 410, fits over the valve support 436, which receives a compliant valve plug 442 at the upper ends thereof. The valve plug 442 closes off an opening 444 of the fluid port 404 when the cap 410 is urged upwardly by the spring 432.

The cap 410 is sealed at the valve supports 416, 418 and the upper end of the dip tube 408 by o-rings. The cap 410 is able to slide downwardly when a force is applied, causing the openings 428, 430 and 444 to be displaced such that the respective valve plugs 424, 426, and 442 are unseated from the respective openings to permit fluid flow through the valves.

The cap 410, which in this embodiment acts as the closure interface, may be coupled to an interconnect similar to the interconnect 104 described above. When the interconnect 104 is coupled to the closure 400, the first cylindrical recess 322 (FIG. 3C) engages the cap 410 and forces the cap downwardly to open the valve plugs 424, 426, and 442.

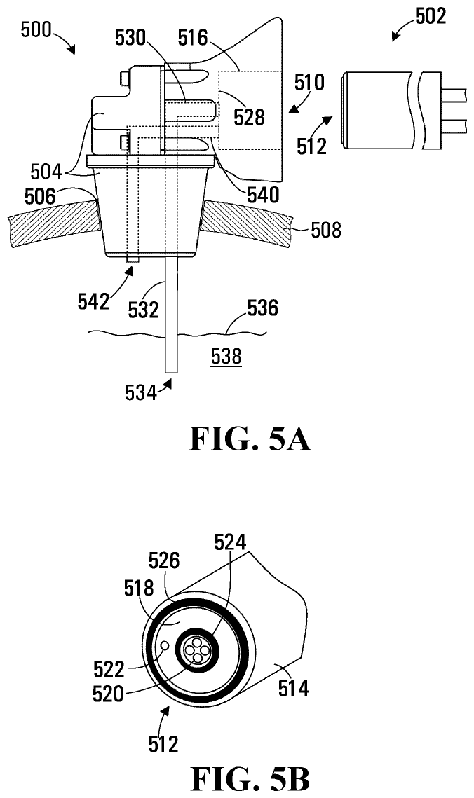

Another embodiment of a closure and interconnect are shown in FIG. 5A at 500 and 502. The closure 500 includes a body 504 that is sealingly received with the an opening 506 of a container 508 (shown in part in FIG. 5A). The body 504 of the closure 500 includes a closure interface 510 and the interconnect 502 includes an interconnect interface 512. Referring to FIG. 5B, the interconnect interface 512 of the interconnect 502 has a cylindrical protruding end 514, which is sized to be received within a cylindrical recess 516 (shown in broken lines) of the closure 500. The interconnect interface 512 has a face 518, which includes a primary fluid port 520 and a secondary fluid port 522, which are separated by an o-ring seal 524. A further o-ring seal 526 extends around a periphery of the interface 512 and encloses the secondary fluid port 522.

When the cylindrical end 514 is received in the recess 516 of the closure 500, the face 518 engages a portion 528 of the cylindrical recess and places the primary fluid port 520 in fluid communication with a first conduit 530 (shown in broken lines). The first conduit 530 extends through the body 504 of the closure 500 and terminates in a dip tube 532 that has an end 534 immersed below a surface 536 of a liquid content 538 in the container 508. The secondary fluid port 522 is similarly placed in fluid contact with a second conduit 540, which terminates in an opening 542 above the surface 536 of the liquid content 538.

Referring back to FIG. 1, the hand controller 110 includes a display 126 and a plurality of buttons 128, which may be actuated by an operator to initiate various operations of the system 102. In the embodiment shown the fluid handler 106 includes a controller 130, which may be implemented using a processor-based controller circuit. The hand controller 110 acts as a user input device for the controller 130 in controlling operations of the system 102. The hand controller 110 may be connected via electrical lines running alongside the fluid line 108, and may include a microcontroller circuit that controls the plurality of buttons 128 and display 126. The electrical lines may include power lines for powering the hand controller 110 and signal lines for communicating operator commands and system status between the hand controller 110 and the controller 130.

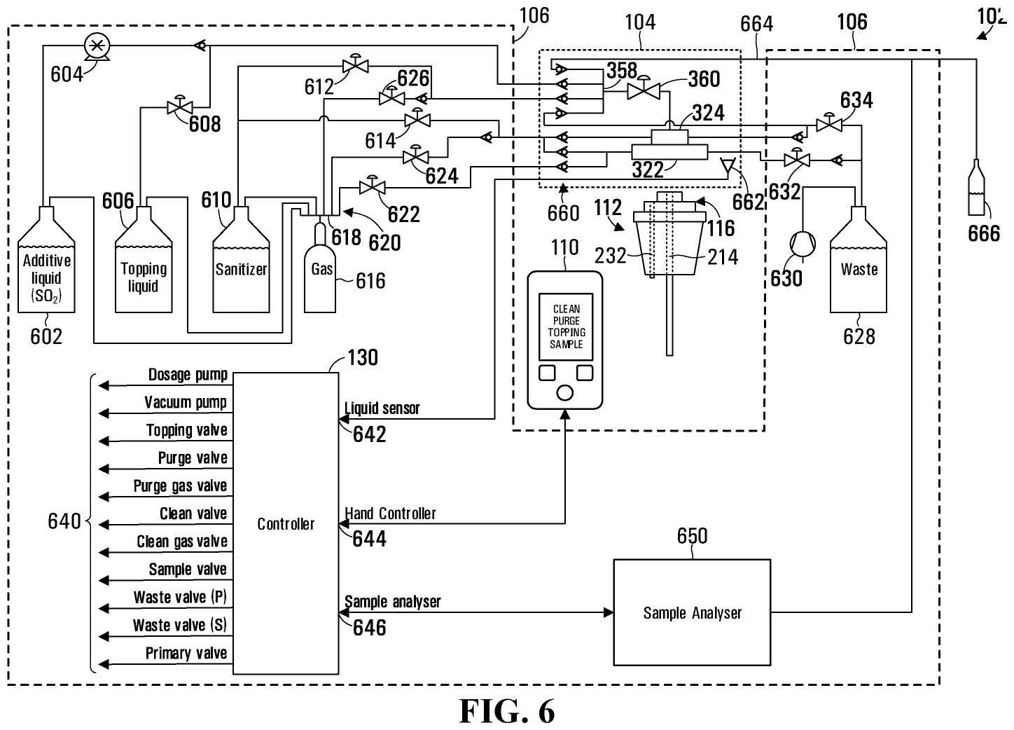

Referring to FIG. 6, a connection diagram showing connections between the fluid handler 106, interconnect 104, hand controller 110, and closure 112 is shown generally at 600. The connections for the system 102 are shown for the specific example of the closure 112 shown in FIGS. 2A and 2B and the interconnect 104 shown in FIGS. 3A-3E. Connections for the closure embodiment shown in FIG. 4A and 4B will be similar. Connections for the embodiment shown in FIGS. 5A and 5B may differ in some minor respects.

In this embodiment the plurality of reservoirs 124 (shown in FIG. 1) are described for an embodiment in which beverage management operations are performed on a wine beverage being held in a wooden barrel container 100, such as shown in FIG. 1. As such the reservoirs 124 and operations described below are suited for managing wine containers, and may differ in some aspects for management of other beverages, such as beer, spirit liquor, or non-alcoholic beverages. In one embodiment the reservoirs 124 may be stainless steel beverage containers such as a keg with ball lock or tri-clamp fittings. Suitable beverage kegs would provide a sealed volume that includes a liquid outlet and a gas inlet for pressurizing the liquid.

The fluid handler 106 includes an additive liquid reservoir 602. The additive liquid may be a solution of potassium metabisulfite, which forms sulfur dioxide (SO₂) that acts as an antioxidant, preservative, and antimicrobial agent for a wine beverage. The additive liquid reservoir 602 is connected to a dosage pump 604 for delivering a measured dose of the additive liquid.

The fluid handler 106 also includes a topping liquid reservoir 606, which holds a liquid for topping off the container 100. The topping liquid may be a liquid of a similar constitution to the bulk liquid in the container 100. Alternatively, the topping liquid may be another liquid, such as water or a mixture or water and the bulk liquid. The topping liquid reservoir 606 is connected to a topping valve 608.

The fluid handler 106 also includes a sanitizer reservoir 610, which holds a sanitizer solution such as an aqueous solution of 80% ethanol. Aqueous ethanol has the advantage of not affecting the taste of alcoholic beverages. The sanitizer reservoir 610 is connected via a tee to a purge liquid valve 612 and a clean liquid valve 614.

The fluid handler 106 also includes a gas reservoir 616 for holding an inert gas such as nitrogen (N₂). The gas reservoir 616 is connected to a gas manifold 618, which distributes gas to a plurality of gas ports 620 for various operations, as described below. In this embodiment the gas manifold 618 may include a pressure regulator (not shown) for each gas port 620, which facilitates gas distribution at different pressures suitable for the intended operations. The gas reservoir 616 is connected via the ports 620 of the gas manifold 618 to a sample gas valve 622, a clean gas valve 624, and a purge gas valve 626. Further gas ports 620 are connected to the additive liquid reservoir 602, topping liquid reservoir 606, and sanitizer reservoir 610 for placing the liquid contents of these vessels under a dispensing pressure.

The fluid handler 106 also includes a waste reservoir 628 for receiving waste liquids, such as overflow wine and sanitizer. The waste reservoir 628 is in fluid communication with a vacuum pump 630, which when operated, lowers the pressure within the waste reservoir. The waste reservoir 628 is also connected via a tee to a pair of waste valves 632 and 634. The fluid handler 106 includes check valves in various fluid lines to prevent inadvertent flows or backflows, as described below.

The controller 130 includes a plurality of electrical signal outputs 640 for controlling operation of the dosage pump 604 and vacuum pump 630, and for controlling the fluid handler valves 608, 612, 614, 622, 624, 626, 632, 634, and the primary valve 360 of the interconnect 104. The output 640 for the dosage pump 604 may be configured as an input/output port in embodiments where the dosage pump transmits signals back to the controller 130, as described later herein. In one embodiment the valves 608, 612, 614, 622, 624, 626, 632, 634, 360 may be diaphragm actuated valves and the electrical signals may be used to drive a plurality of solenoid valves (not shown) that selectively apply a pressure to the various valves. The solenoid valves may be connected to an additional port 620 on the gas manifold 618 for receiving a pressurized gas supply. Alternatively, the pressure for operating the valves may be provided by a compressed air source. In other embodiments, the valves 608, 612, 614, 622, 624, 626, 632, 634, and 360 may be implemented as solenoid actuated valves that receive electrical drive signals via the outputs 640.

In this embodiment the controller 130 also includes an input 642 for receiving a signal from a flow indicator 662, which will be described in more detail below. The controller 130 further includes an input/output 644 for receiving and transmitting signals between the hand controller 110 and the controller. In one embodiment the interface between the controller 130 and the hand controller 110 may be implemented using a Controller Area Network bus (CAN bus). In other embodiments the hand controller may include a wireless interface for interfacing with a wireless interface of the controller 130. In this embodiment of the interconnect 104 a plurality of check valves 660 are shown in the fluid lines leading into the interconnect. The check valves 660 may be located in-line in the fluid lines within the rear cover 304 of the interconnect 104 shown in FIG. 3A, and are operable to prevent unintended fluid flows into or out of the interconnect. In this embodiment the fluid handler 106 includes a sample analyzer 650, which is connected to an input/output 646 of the controller 130 via a signal line for receiving and transmitting signals between the controller and the sample analyzer. The sample analyzer 650 may be implemented to perform analysis operations on a sample drawn from the container 100 as described in more detail below.

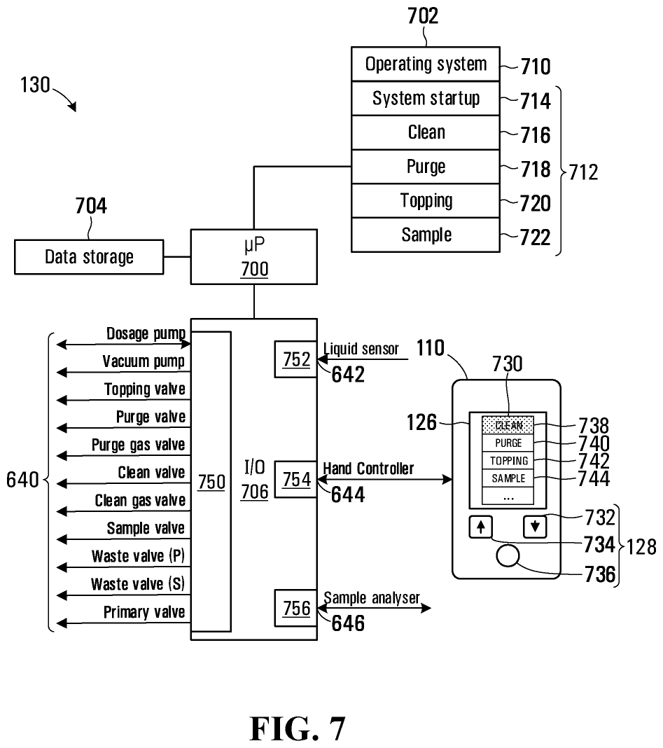

In one embodiment the controller 130 may be implemented as a processor circuit 700, configured generally as shown in FIG. 7. The controller processor circuit 130 includes a microprocessor 700, a program memory 702, a variable memory 704, and an input output port (I/O) 706, all of which are in communication with the microprocessor 700. Program codes for directing the microprocessor 700 to carry out various functions are stored in the program memory 702, which may be implemented as a random access memory (RAM) and/or a hard disk drive (HDD), or a combination thereof. The program memory includes a first block of program codes 710 for directing the microprocessor 700 to perform operating system functions. The program memory also includes blocks of program codes 712 for directing the microprocessor 700 to perform various functions related to beverage management. The variable memory 704 includes a plurality of data storage locations for storing data and results related to beverage management operations. The variable memory 704 may be implemented in random access memory or flash memory, for example.

The I/O 706 includes an interface 750 for generating the electrical signal outputs 640 as shown in FIG. 6 and an interface 752, which provides the input 642 for receiving the liquid sensor input from the flow indicator 662. The I/O 706 also includes an interface 754 that provides the input/output 644 for communicating with the hand controller 110, and an interface 756 that provides the input/output 646 for communicating with the sample analyzer 650.

In other embodiments (not shown), the controller 130 may be partly or fully implemented using a hardware logic circuit including discrete logic circuits, an application specific integrated circuit (ASIC), and/or a field-programmable gate array (FPGA), for example.

Operations of the system 102 to perform various functions will be described below with reference to a number of different operations that may be performed as part of a beverage management process. Each container may have the closure 112 installed for the duration of the processing of the wine in the containers. Alternatively, as described above in connection with FIG. 3E where the closure is integrated in the unitary interconnect 380, each container 100 would have a conventional bung closure, which would be removed to perform beverage management operations.

When the system 102 is first started, the controller loads the operating system codes 710 and then loads the startup program codes 714. The startup program codes 714 include codes that communicate with the hand controller 110 to cause the hand controller to display a startup menu 730. The operator is able to select a beverage management function from the startup menu 730 by operating the plurality of buttons 128. For example, the operator may operate an up button 732 and a down button 734 to is highlight one of the functions on the menu. The selected function is then initiated by the operator pressing an enter button 736. In the example shown in FIG. 7, the clean function 738 is highlighted and when selected causes the microprocessor 700 to execute a block of program codes 716 associated with a “CLEAN” function.

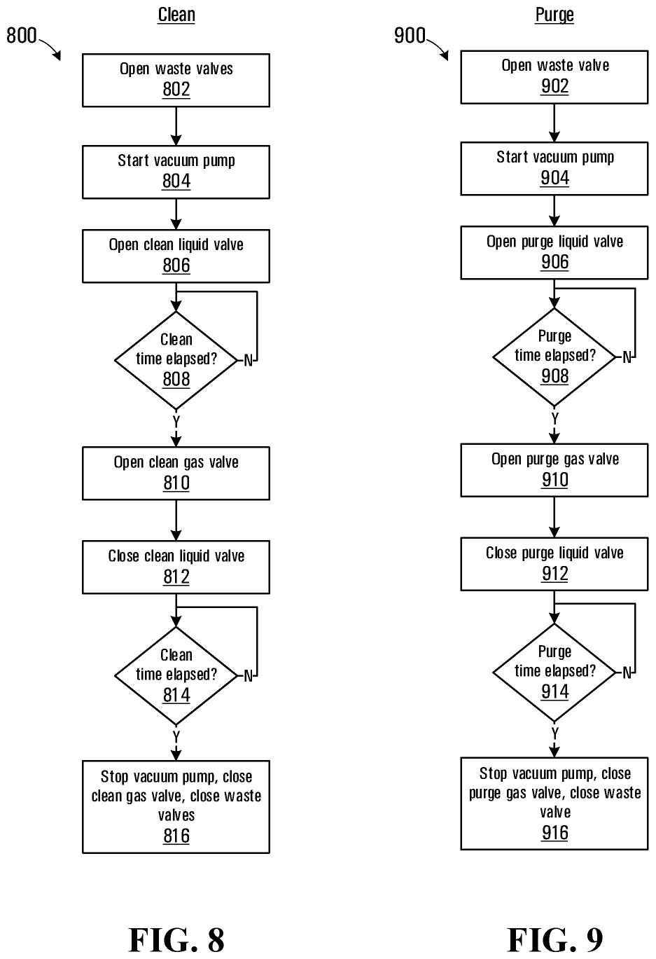

Referring to FIG. 8, a clean process 800 may be performed prior to beginning beverage management operations and prior to performing other operations such as topping up the container 100 with a topping liquid. The clean process generally involves delivering a sanitizer flow to the interconnect interface 302 and/or the closure interface 116 via the secondary fluid port.

The clean process 800 is shown as a flowchart depicting blocks of code for directing the controller processor circuit 130 to perform beverage management functions. The blocks generally represent codes that may be read from the program memory. The actual code to implement each block may be written in any suitable program language, such as C, C++, C#, Java, and/or assembly code, for example. The clean process generally flushes and sanitizes the interconnect interface 302 of the interconnect 104 (i.e. the first cylindrical recess 322 and second cylindrical recess 324 in FIG. 6). The process 800 begins at block 802, which directs the microprocessor 700 to cause the I/O 706 and interface 750 to generate a signal for opening both waste valves 632 and 634, to place the waste reservoir 628 in fluid communication with the first and second cylindrical recesses 322 and 324 of the interconnect 104. As disclosed above in connection with FIG. 3C, the first cylindrical recess 322 includes secondary fluid ports 332 and 334, one of which may be configured as a delivery port for delivering the sanitizer flow, and the other as a discharge port for discharging the sanitizer. Similarly, the second cylindrical recess 324 includes secondary fluid ports 328 and 330, one of which may be configured as a delivery port for delivering the sanitizer flow, and the other as a discharge port for discharging the sanitizer. In this case the waste reservoir 628 is placed in fluid communication with the respective discharge ports. Block 804 then directs the microprocessor 700 to cause the I/O 706 and interface 750 to generate a signal for starting the vacuum pump 630. The vacuum pump draws air from a headspace of the waste reservoir 628, initially causing air to be drawn through the respective discharge ports in the cylindrical recesses 322 and 324 of the interconnect 104.

The clean process 800 then continues at block 806 to generate a clean liquid valve signal output 640 for opening the clean liquid valve 614, to place the sanitizer reservoir 610 in fluid communication with the first and second cylindrical recesses 324 and 322 of the interconnect 104 via the respective delivery ports. The sanitizer reservoir 610 is pressurized by the gas reservoir 616 via the connected gas port 620 of the gas manifold 618, which causes sanitizer solution to be forced out of the sanitizer reservoir and delivered through the clean liquid valve 614, through the check valve 660, and to the cylindrical recesses 324 and 322 of the interconnect 104. In one embodiment the gas pressure may be about 10 pounds per square inch (psi). A check valve following the clean gas valve 624 prevents sanitizer from flowing back into the clean gas line. Referring back to FIG. 3C, the operating configuration set up by the clean process 800 thus causes a sanitizer flow to be delivered within each of the cylindrical recesses 322 and 324 at the respective delivery ports, while a vacuum flow is being drawn out from the respective discharge ports. This causes a generally swirling fluid flow about the cylindrical recesses 322 and 324, which will impinge on the surfaces of the recesses to sanitize the interconnect interface 302. Some of the sanitizer will escape from the cylindrical recesses 322 and 324, while some will be drawn through the respective discharge ports and vented into the waste reservoir 628. The clean process 800 thus involves the delivering a first flow of liquid sanitizer followed by a second gaseous flow to cause the liquid sanitizer to be discharged from the interconnect interface 302 via the discharge port.

Block 808 of the clean process 800 then directs the microprocessor 700 to determine whether a first clean time associated with the sanitizer flow has elapsed. In one embodiment the first clean time may be about 1 second. If at block 808 the time has not yet elapsed, the microprocessor 700 is directed to repeat block 808. When at block 808 the time has elapsed, the microprocessor 700 is directed to block 810. Block 810 directs the microprocessor to open the clean gas valve 624, which allows gas to be delivered via the check valves to the first and second cylindrical recesses 322 and 324. In one embodiment, the sanitizer flow may be maintained for a short time in combination with the gas flow, until block 812 directs the microprocessor 700 to close the clean liquid valve 614. Block 814 of the clean process 800 then directs the microprocessor 700 to determine whether a second clean time associated with the gas flow has elapsed. The gas flow is maintained for a sufficient time to substantially disperse and/or discharge the sanitizer, thus removing excess sanitizer from the interconnect interface 302. In one embodiment the second clean time may be about 2-4 seconds. If at block 814 the second clean time has not yet elapsed, the microprocessor 700 is directed to repeat block 814. When at block 814 the time has elapsed, the microprocessor 700 is directed to block 816. Block 816 directs the microprocessor 700 to complete the clean process 800, by stopping the vacuum pump 630, closing the clean gas valve 624, and closing the waste valves 632 and 634. The clean process 800 flushes the first and second cylindrical recesses 322 and 324 with sanitizer to destroy any pathogenic and other kinds of microorganisms that may have contaminated the interconnect interface 302.

Referring to FIG. 7, if a function 740 is highlighted and selected on the menu 730 of the hand controller 110, the microprocessor 700 executes a block of program codes 718 associated with the “PURGE” function. Referring to FIG. 9, a purge process is shown as a process flowchart generally at 900. The purge process 900 is associated with purging fluid lines and the manifold 358 of the interconnect 104 (shown in FIG. 3D). During operation, the primary fluid lines 306 may be at least partially filled with a wine other than the wine currently being managed, due to prior operations on another batch of wine containers. The purge process 900 thus generally flushes and sanitizes the manifold 358 and primary line bore 350 while the primary valve 360 remains closed off.

The process purge 900 begins at block 902, which directs the microprocessor 700 to open the waste valve 634 to place the waste reservoir 628 in fluid communication with the manifold 358. Block 904 then directs the microprocessor 700 to generate a signal for starting the vacuum pump 630. Block 906 then directs the microprocessor 700 to open the purge liquid valve 612, to place the sanitizer reservoir 610 in fluid communication with the manifold 358. The pressurization of within the sanitizer reservoir 610 causes sanitizer solution to be forced out of the sanitizer reservoir and delivered through the purge liquid valve 612, through the check valve 660, and to the manifold 358. The sanitizer thus enters the manifold 358 via one of the primary fluid lines 306 connected to the purge liquid valve 612 and leaves the manifold via another of the primary fluid lines 306 connected via the waste valve 634 to the waste reservoir 628. A check valve following the purge gas valve 626 prevents sanitizer from flowing back into the purge gas line. The sanitizer solution may also reach along the primary bore 350 to the valve bore 352, thus also flushing this portion of the interconnect 104 with sanitizer.

Block 908 of the purge process 900 then directs the microprocessor 700 to determine whether a first purge time associated with the sanitizer flow has elapsed. In one embodiment the first purge time may be about 1-2 seconds. If at block 908 the time has not yet elapsed, the microprocessor 700 is directed to repeat block 908. When at block 908 the time has elapsed, the microprocessor 700 is directed to block 910. Block 910 directs the microprocessor to open the purge gas valve 626, which allows gas to be delivered via the check valves to the manifold 358. In one embodiment, the sanitizer flow may be maintained for a short time in combination with the gas flow, until block 912 directs the microprocessor 700 to close the purge liquid valve 612. Block 914 of the purge process 900 then directs the microprocessor 700 to determine whether a second purge time associated with the gas flow has elapsed. The gas flow is maintained for a sufficient time to substantially disperse and/or discharge the sanitizer through the waste line to the waste reservoir 628, thus removing excess sanitizer from the manifold 358. In one embodiment the second purge time may be about 3-5 seconds. If at block 914 the time has not yet elapsed, the microprocessor 700 is directed to repeat block 914. When at block 914 the time has elapsed, the microprocessor 700 is directed to block 916. Block 916 directs the microprocessor 700 to complete the purge process 900, by stopping the vacuum pump 630, closing the purge gas valve 626, and closing the waste valve 634. The purge process 900 flushes the manifold 358 with sanitizer to destroy any pathogenic and other kinds of microorganisms that may have contaminated the manifold.

Generally, the purge process 900 may be performed when the system 102 is prepared for performing beverage management operations. The purge process 900 may also be performed after a series of functions have been performed on containers associated with a particular wine. The process 900 flushes traces of the prior wine batch from interior surfaces of the interconnect 104, to prepare for use of the system 102 with another wine batch. Alternatively, or additionally, the purge function may be initiated prior to commencing operations on a new batch of wine. Since the purge process 900 is internal to the interconnect 104, the process may be initiated either coupled to the closure 112 or decoupled from the closure.

The clean process 800 may also be performed when preparing the system 102 for operation. The clean process 800 may also be initiated after operations on a particular container 100 have been completed, which sanitizes the interconnect interface 302 and the closure 112 prior to or during removal of the interconnect 104 from the closure interface 116. The remaining functions described below require the interconnect 104 to be coupled to the closure 112, as shown in FIG. 3D. These processes involve introduction or removal of wine from the container 100 and are generally only performed after cleaning and purging the interconnect 104.

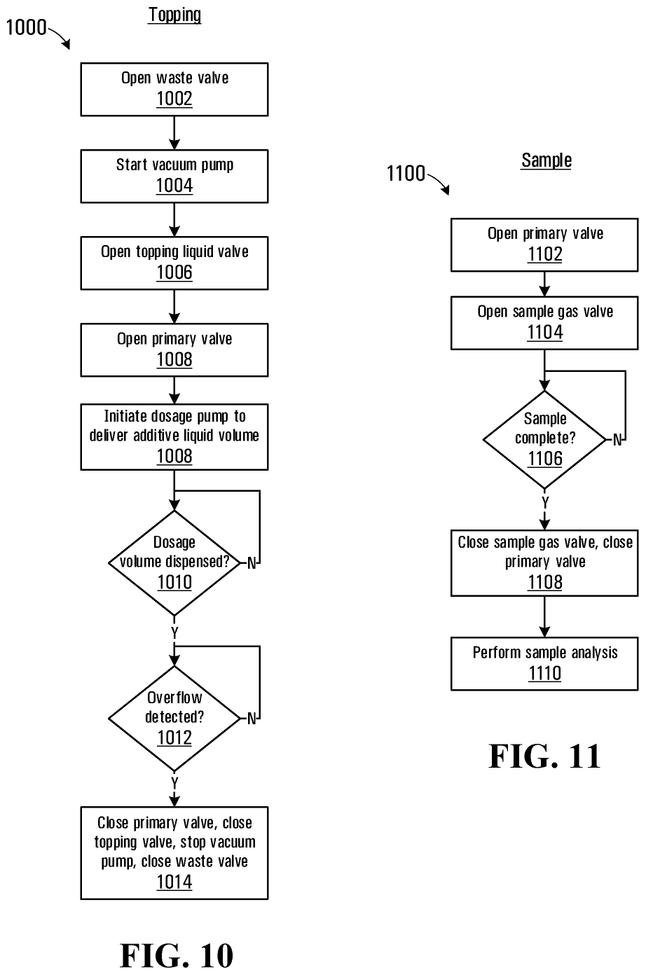

Referring back to FIG. 7, if a function 742 is highlighted and selected on the menu 730 of the hand controller 110, the microprocessor 700 executes a block of program codes 720 associated with the “TOPPING” function. As disclosed above, for a beverage held within a wood barrel container, it is frequently necessary to refill or top-up the container 100 to account for evaporation of the beverage. Referring to FIG. 10, a process flowchart associated with the topping process is shown generally at 1000. The topping process 1000 begins at block 1002, which directs the microprocessor 700 to open the waste valve 632. Block 1004 then directs the microprocessor 700 to start the vacuum pump 630. The waste reservoir 628 is thus placed in fluid communication with the second conduit 232 of the closure 112 via the first cylindrical recess 322. Block 1006 then directs the microprocessor 700 to open the topping valve 608, which places the topping liquid reservoir 606 in fluid communication with the manifold 358. The topping liquid reservoir 606 is pressurized by the gas reservoir 616 via the connected gas port 620 of the gas manifold 618. In one embodiment the gas pressure may be about 15 psi. At this time, topping liquid is still prevented from flowing by the primary valve 360.

The topping process 1000 then continues at block 1008 which directs the microprocessor to cause the primary valve 360 to be opened. When opened the primary valve 360 places the manifold 358 in fluid communication with the first conduit 214 of the closure 112, via the primary fluid port 326 and second cylindrical recess 324, as described above in connection with FIG. 3D. The vacuum pump 630 will have caused a reduction in pressure within the container 100, which causes topping liquid to be drawn in from the topping liquid reservoir 606 through the primary valve 360 and the already opened topping valve 608, and through the first conduit 214 into the container 100. In this embodiment the pressure generated by the vacuum pump 630 is selected such that, for a given pressure in the topping liquid reservoir 606, the container 100 is maintained at a pressure near atmospheric pressure. A wood barrel is subjected to a pressure above atmospheric pressure may cause the wooden staves to flex outwardly, potentially opening up passages between the staves that would permit escapement of wine. This problem is avoided in this embodiment by causing a reduction of pressure at the secondary fluid port to permit a fluid to vent through the secondary fluid port while topping up a level of the bulk fluid in the container.

Block 1008 then directs the microprocessor 700 to generate a command at the dosage pump output 640 of the controller 130 to initiate operation of the dosage pump 604. The dosage pump 604 may be a constant displacement pump that is configured to accurately dispense a volume of liquid. The command received from the controller 130 may include the pre-determined volume to be dispensed by the dosage pump 604. Block 1008 thus directs the microprocessor 700 to meter out a pre-determined volume of the additive liquid from the additive liquid reservoir 602. The additive liquid reservoir 602 is pressurized by the gas reservoir 616 via the gas manifold 618 and one of the gas ports 620, in one embodiment at a pressure of about 10 psi. In some embodiments the dosage quantity may be predetermined based on an analysis of a prior sample taken from one or more of the containers associated with a batch of wine. Block 1010 then directs the microprocessor 700 to determine whether the commanded dosage volume has been dispensed. In some embodiments the dosage pump 604 may be operably configured to signal the controller 130 to indicate that the dispensing of the volume of additive liquid has been completed. The microprocessor 700 may thus be configured to deliver a target metered dosage of additive liquid to the beverage in the container 100.

The additive liquid is thus mixed in with the topping liquid during the topping of the container 100. This has the advantage of delivering diluted topping liquid to the container, which reduces the possibility of overdosing a portion of the wine that may occur if the additive liquid were to be introduced through the first conduit 214 in absence of topping liquid. The introduction of the topping liquid and additive liquid within the bulk of the wine in the container 100 prevents splashing and also causes some circulation of the wine to promote mixing between the existing wine and the topping liquid. The quantity of topping liquid being introduced will generally exceed the volume of additive liquid being dispensed and the additive liquid volume will have been completely dispensed prior to the container 100 being topped up.

The topping process 1000 then continues at block 1012 which directs the microprocessor 700 to determine whether an overflow has occurred in the waste line connected to the first cylindrical recess 322. While the container 100 is being topped off, a gaseous headspace in the interior of the container will vent through the second conduit 232, through the first cylindrical recess 322 and waste valve 632, and into the waste reservoir 628. When the container 100 is fully topped off, the gaseous flow will change to a bulk liquid flow (i.e. wine). In the embodiment shown in FIG. 6, the flow indicator 662 is implemented as a sensor that detects a change in fluid flow and generates a signal for receipt by the controller 130 at the liquid sensor input 642. The sensor may be an optical sensor disposed to detect changes in flow through the secondary fluid line, or a resistive sensor disposed to sense changes in resistivity associated with flows through the secondary fluid line. In other embodiments the flow indicator may be implemented as a window 374 (shown in FIGS. 3A and 3D) above a portion of the fluid line. The operator would thus be able to view the fluid line while topping and detect a change in fluid flowing through the line and operate one of the buttons 128 on the hand controller 110 to stop the flow of tipping liquid. When at block 1012, an overflow of fluid is detected the microprocessor 700 is directed to block 1014. Block 1014 directs the microprocessor to close the primary valve 360, close the topping valve 608, stop the vacuum pump 630, and close the waste valve 632, which completes the topping process 1000.

In the embodiments of the closure 112 describe above, the dip tube 220 is long enough to have its end 216 disposed below the surface of the liquid contents of the container 100.

For cases where the beverage in the container 100 is a wine being aged on its lees (i.e. a yeast residue), the lees may be agitated by modulating a pressure and flow of the introduced topping liquid. The stirring of lees is fairly common in aged white wine production for increasing contact between yeast residue and the bulk of the wine to impart certain flavors to the finished product. This modulation may be accompanied by a gaseous agitation generated by injecting a sparging gas such as nitrogen. For the fluid handler 106 embodiment shown in FIG. 6, this may involve configuring a valve at the gas manifold 618 to provide a modulated gas flow for the port 620 associated with the sanitizer reservoir 610. An additional gas port 620 and valve may be provided to inject the gaseous agitation into the topping liquid. The combination of the pressure and flow modulation along with gaseous agitation disturbs and distributes the lees, which typically accumulate at the bottom of the container. In some embodiments a length of the dip tube 220 may be selected to place the point of introduction of the topping liquid closer to a bottom surface of the container 100. Stirring the wine lees in this way has an advantage over traditional batonage methods of stirring, which generally require insertion of a mechanical stirring instrument in that winemakers are able to agitate the contents of the barrel without opening and potentially contaminating the contents.

Referring back to FIG. 7, if a function 744 is highlighted and selected on the menu 730 of the hand controller 110, the microprocessor 700 executes a block of program codes 722 associated with the “SAMPLE” function. The sample function may be initiated to draw a sample of the beverage from the container 100 for analysis. In some cases where there is a risk of cross-contamination between containers, the purge process 900 may be used to flush and sanitize the manifold 358 before (or after) each sample is drawn. For example, if a sample were drawn through the manifold 358 that may potentially be contaminated by a microbe, such as Brettanomyces, the purge process 900 would act to sanitize common wetted areas of the manifold 358 and prevent biological contamination transfer between containers.

Referring to FIG. 10, a process flowchart associated with the sample process is shown generally at 1100. The sample process 1100 begins at block 1102, which directs the microprocessor 700 to open the primary valve 360 to place the manifold 358 in fluid communication with the first conduit 214. Block 1104 then directs the microprocessor 700 to open the sample gas valve 622. This causes a gas pressure to be applied via the gas manifold 618 and the sample gas port 620, via the delivery fluid port and sample gas valve 622, to the first cylindrical recess 322. The sample pressure is thus applied to the contents of the container 100 via the second conduit 232. In one embodiment the sample pressure may be about 3 psi. In either case the pressure causes an outflow of the wine from the container 100, through the first conduit 214, the second cylindrical recess 324, primary valve 360, and the primary fluid port 326, and into the manifold 358. Since the waste valve 634 remains closed, the wine can only flow out of check valve 660 of the manifold into a sample line 664. In embodiments where the system 102 includes the sample analyzer 650, the sample may be delivered to the sample analyzer for analysis. In other embodiments the sample may be delivered via an external branch of the sample line 664 to a sample container 666, which may be taken to a laboratory for analysis. Block 1106 directs the microprocessor 700 to determine whether the sample is completed. In embodiments where the sample is delivered to the sample analyzer 650, the microprocessor 700 may be operably configured to cause a pre-determined sample volume to be withdrawn. The microprocessor 700 may thus monitor signals from the sample analyzer 650 at the input/output 646 to determine when the analyzer has received a sufficient sample volume for analysis. In other embodiments where the sample is delivered to the sample container 666, the microprocessor 700 may be configured to dispense the sample in response to one of the plurality of buttons 128 on the hand controller 110 being held down by the operator. When the operator determines that the sample container 666 has been sufficiently filled, the button 128 may be released, thus signaling the microprocessor 700 via the input/output 644 that the sample is complete. When it is determined that the sample is complete at block 1106, block 1108 directs the microprocessor 700 to close the sample gas valve 622 and to close the primary valve 360.

In embodiments of the fluid handler 106, that include the sample analyzer 650, the sample process 1100 then continues at block 1110, which directs the microprocessor 700 to produce signals at the input/output 644 to cause the sample analyzer 650 to process the delivered sample. Various types of analysis may be performed on the sample, which may differ depending on the beverage (for example, wine, beer, or spirit). The analysis may involve determining the concentration of free, total, or molecular sulfite compounds in the sample. Various other chemical and thermodynamic metrics may be determined, for example, pH, temperature, dissolved oxygen levels, or volatile acid concentration.

In some embodiments the sample analyzer may be implemented as a modular analyzer block that includes its own controller. In this case, once the sample analysis is completed the sample analyzer 650 controller will transmit the results to the input/output 644. The results may initially be stored in the variable memory 704 and/or transmitted or downloaded to a centralized management processing system (not shown) for analysis and recording in a database. As an example, a winery may implement a centralized management system for recording and analyzing data related to beverages being held in containers in the winery. In another example, the sample analyzer 650 may determine a sulphite level of a wine, which is stored in the memory 704. Subsequently, when performing the topping process 1000, the microprocessor 700 may be configured to automatically calculate an additive liquid dosage to be mixed in with the topping liquid, based on the sulphite measurement stored in the memory 704. In some embodiments, the sample analysis and determination of sulphite dosage may be made on a container-by-container basis, such that each specific container only receives the necessary dosage of sulphite additive liquid. This has the advantage of customizing the dosage for each container, rather than dosing all containers holding the same wine based on an average determined for samples taken from a few of the containers, as is common in the wine industry.

While the above processes have been described in the context of being implemented automatically or semi-automatically, in some embodiments the fluid handler 106 may be implemented without the controller 130 or with a less functional controller. In this case the hand controller 110 may provide various control buttons for actuating the valves generally as described above to manually perform the beverage management operations.

While specific embodiments have been described and illustrated, such embodiments should be considered illustrative only and not as limiting the disclosed embodiments as construed in accordance with the accompanying claims.

1. A closure apparatus for a bulk liquid beverage container, the closure apparatus comprising:
a body operably configured to be sealingly received within an opening of the container, the body having an outwardly disposed closure interface including first and second fluid ports each sealed by a valve;
a first conduit extending through the body from the first fluid port and having an end disposed to be immersed within a liquid content of the container when the body is received in the opening;
a second conduit extending through the body from the second fluid port and having an end disposed for fluid communication with an interior of the container when the body is received in the opening; and
wherein first and second fluid ports are configured to be placed in fluid communication with fluid lines of an interconnect when the interconnect is coupled to the closure interface.

2. The apparatus of claim 1 wherein the first conduit further comprises a dip tube in fluid communication with the first conduit and protruding beyond the body, and wherein the end of the first conduit is disposed at an end of the dip tube.

3. The apparatus of claim 1 wherein the closure interface comprises one of:
a cylindrical protrusion disposed on the body, the cylindrical protrusion configured to be received within a cylindrical recess of the interconnect; or
a cylindrical recess in the body, the cylindrical recess configured to receive a cylindrical portion of the interconnect.

4. The apparatus of claim 3 wherein the cylindrical protrusion comprises a first cylindrical protrusion disposed on the body and a second cylindrical protrusion disposed on the first cylindrical protrusion, and wherein the valve comprises at least one displaceable valve disposed on the second cylindrical protrusion and associated with the second conduit, and at least one displaceable valve disposed on the first cylindrical protrusion and associated with the second conduit.

5. The apparatus of claim 3 further comprising a circumferential groove on a sidewall of the cylindrical protrusion, the cylindrical groove being operably configured to be engaged by a retainer for interlocking the interconnect and the closure apparatus when the interconnect is coupled to the closure interface.

6. The apparatus of claim 1 wherein the valve comprises:
at least one displaceable valve associated with the first conduit; and
at least one displaceable valve associated with the second conduit.

7. The apparatus of claim 6 wherein the at least one displaceable valve associated with the second conduit is operably configured to open when the interconnect is coupled to the closure interface.

8. The apparatus of claim 6 wherein the at least one displaceable valve associated with the first conduit is operably configured to:
remain closed when the interconnect is initially coupled to the closure interface; and
open in response to being actuated to open by the interconnect.

9. The apparatus of claim 8 wherein the interconnect comprises a primary valve sealing the primary fluid line, the primary valve being actuable to open to permit inflow or outflow of fluid through the primary fluid line, and wherein the at least one displaceable valve associated with the first conduit is actuated when the primary valve is opened.

10. The apparatus of claim 1 wherein the second fluid port comprises a plurality of fluid ports each having an associated second conduit portion extending through the body and having respective ends disposed for communication with the interior of the container.

11. An interconnect apparatus for coupling to the closure interface of the closure apparatus of claim 1, the interconnect apparatus comprising:
a body;
an interconnect interface;
a primary fluid line extending through the body and terminating in a primary fluid port at the interconnect interface, the primary fluid port being disposed to be placed in fluid communication with the first conduit when the interconnect interface is coupled to the closure interface; and
a secondary fluid line extending through the body and terminating in a secondary fluid port at the interconnect interface, the secondary fluid port disposed to be placed in fluid communication with the second conduit when the interconnect interface is coupled to the closure interface.

12. The interconnect apparatus of claim 11 further comprising a primary valve sealing the primary fluid port, the primary valve being operable to open to permit inflow or outflow of fluid through the primary fluid port when actuated.

13. An interconnect apparatus for coupling to a closure sealingly received within an opening of a bulk liquid container, the closure including a closure interface having first and second fluid ports, the interconnect apparatus comprising:
a body;
an interconnect interface including:
a primary fluid port in fluid communication with a primary fluid line extending through the body;
a secondary fluid port in fluid communication with a secondary fluid line extending through the body, the primary fluid port and the secondary fluid port being disposed to be placed in fluid communication with the respective first and second fluid ports of the closure when the interconnect interface is coupled to the closure interface; and
a primary valve sealing the primary fluid port, the primary valve being operable to open to permit inflow or outflow of fluid through the primary fluid port when actuated.

14. The apparatus of claim 13 wherein the secondary fluid port comprises a delivery port for delivering fluid flow and a discharge port for discharging fluid.

15. The apparatus of claim 13 wherein the interconnect interface comprises a cylindrical protrusion configured to be received in a cylindrical recess of the closure interface.

16. The apparatus of claim 13 wherein the interconnect interface comprises a cylindrical recess configured to receive a cylindrical protrusion of the closure interface.

17. The apparatus of claim 16 wherein the cylindrical recess comprises a first cylindrical recess disposed to couple with a first cylindrical protrusion of the closure interface and a second cylindrical recess disposed to couple with a second cylindrical protrusion of the closure interface, the second cylindrical recess being in fluid communication with the primary fluid port.

18. The apparatus of claim 17 wherein the wherein the secondary fluid port comprises:
a first delivery port for delivering fluid flow to the first cylindrical recess and a first discharge port for discharging fluid from the first cylindrical recess; and
a second delivery port for delivering fluid flow to the second cylindrical recess and a second discharge port for discharging fluid from the second cylindrical recess.

19. The apparatus of claim 13 wherein the primary fluid line comprises a plurality of primary fluid lines terminating into a manifold within the body, the manifold being in fluid communication with the primary fluid port.

20. The apparatus of claim 13 further comprising a flow indicator for detecting an outflow of bulk liquid through the secondary fluid port.

21. The apparatus of claim 20 wherein the flow indicator comprises one of:
a sight glass disposed on the body to facilitate observation of a fluid flowing through the secondary fluid line;
an optical sensor disposed to detect changes in flow through the secondary fluid line; or
a resistive sensor disposed to sense changes in resistivity associated with flows through the secondary fluid line.

22. The apparatus of claim 13 wherein the interconnect is operably configured for one of:
removably coupling to the closure; or
forming a unitary interconnect and closure.

23.-39. (canceled)
